(19) United States
(12) Patent Application Publication
(10) Pub. No.: US 2008/0143492 A1
(43) Pub. Date: Jun. 19, 2008

(54) POWER LINE COMMUNICATION (PLC) SYSTEM

(75) Inventors: Aric Shaffer, Ypsilanti, MI (US); Ronald Miller, Saline, MI (US); Dan Raceu, Warren, MI (US); Gurpreet Aulakh, Brownstown Twp., MI (US); Reno Van Ramsey, Sterling Heights, MI (US)

Correspondence Address: BROOKS KUSHMAN P.C./FGTL, 1000 TOWN CENTER, 22ND FLOOR, SOUTHFIELD, MI, 48075-1238, US

(73) Assignees: FORD GLOBAL TECHNOLOGIES, LLC, Dearborn, MI (US); VALEO ELECTRONICS AND CONNECTIVE SYSTEMS, Auburn Hills, MI (US)

(21) Appl. No.: 11/611,354

(22) Filed: Dec. 15, 2006

(51) Int. Cl. B60Q 1/00; G05B 11/01

(52) U.S. Cl. 340/310.11; 340/425.5

(57) ABSTRACT

The embodiments described herein include a control system and method configured to communicate over a power line. The system includes a transmitting device configured to generate a carrier signal having a predetermined frequency over the power line. A receiving device is also included wherein it filters signals not having the predetermined frequency and receives the carrier signal. Accordingly, the receiving device activates an electrical device in response to the carrier signal.

### TECHNICAL FIELD

The embodiments described herein relate to a power line communication (PLC) system.

### BACKGROUND

Electrical systems typically include a switch being coupled to an electronic device, wherein the electronic device may be actuated or energized. As commonly known, the switch enables or inhibits the flow of electric current to the device so as to cause or disable device actuation. In the context of conventional vehicular electrical systems, coupling of electrical system components occurs through the use of electrical wires. However, the required wiring infrastructure that enables communications with the electronic devices is a concern as vehicle packaging space is limited.

The embodiments described herein were conceived in view of these and other disadvantages of conventional communications systems.

### SUMMARY

The embodiments described herein include a communication system and method configured to communicate over a power line. The system includes a transmitting device configured to generate a carrier signal having a predetermined frequency over the power line. A receiving device is also included wherein it filters signals not having the predetermined frequency and receives the carrier signal. Accordingly, the receiving device activates an electrical device in response to the carrier signal.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a vehicle having a power line communication (PLC) system in accordance with an embodiment of the present invention;

FIG. 2 illustrates a vehicle having a PLC system in accordance with an alternative implementation;

FIGS. 3A and 3B illustrate block diagrams of PLC transmitting devices in accordance with embodiments of the present invention; and

FIGS. 4A and 4B illustrate alternative embodiments of a PLC receiving device in accordance with embodiments of the present invention.

### DETAILED DESCRIPTION OF THE EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

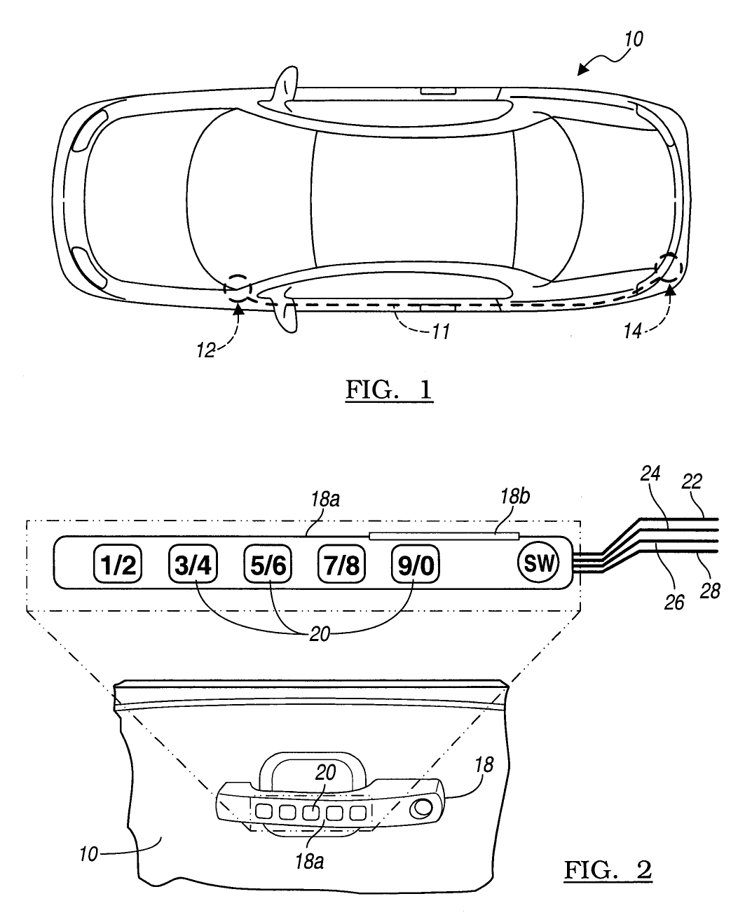

The embodiments described herein include a power communication line (PLC) system that enables communication between electrical components and/or devices over a direct current (DC) power line. The PLC system described herein may be installed during assembly of a system having a DC power line or retrofitted to virtually any power line to enable communications, actuation, energization, and/or activation of electrical devices. FIG. 1 illustrates a non-limiting example of a PLC system being located on a vehicle 10. It is recognized, however, that although some embodiments described herein are described as being implemented on a vehicle, the present invention is equally applicable to non-vehicle applications without departing from the scope of the invention.

Regarding vehicle 10, it includes a power line 11 that enables the transmission of signals from a transmitting device 12 to a receiving device 14. As described above, power line 11 may be a DC power line. Transmitting device 12 may include a switch being coupled to transmitter circuit. For example, transmitting device 12 may include a lamp switch being coupled to a transmitter circuit for energizing or de-energizing lamps on vehicle 10. Transmitting device 12 may be a transmitter circuit that generates control signals for other vehicular devices and systems in response to inputs from a switch, controller and the like.

Receiving device 14 may include a receiving circuit that is coupled to an electronic device. As shown in FIG. 1, receiving device 14 may include a receiving circuit being coupled to a vehicle's lighting system. Receiving device 14 may energize or de-energize vehicle lamps in response to signals transmitted by transmitting device 12. In the context of vehicles, although the present invention is not so limited, receiving device 14 may include a receiving circuit configured to receive and process signals from transmitting device 12 so as to energize, actuate, and/or activate electrical devices that are operable with vehicle 10.

Transmitting device 12 and receiving device 14 are configured to automatically select various communication frequencies to enable optimal and efficient transmission of control signals and the like. In one aspect, multiple transmitting devices and receiving devices may communicate over power line 11. As such, each pair of transmitting and receiving devices may utilize different transmitting frequencies so as to minimize signal congestion and interference.

The signals transmitted by transmitting device 12 include sinusoidal signals having a desired or predetermined frequency. These sinusoidal signals may be referred to as carrier signals. Receiving device 14 is configured to filter signals not having the predetermined frequency and receive the carrier signal. It is recognized that in some embodiments, transmitting device 12 and receiving device 14 may be implemented as a unitary device or transceiver.

In some cases, multiple transmitting devices may utilize a single power line. Accordingly, based on whether a desired frequency has previously been used by other devices on a specific power line, transmitting device 12 is configured to select alternative frequencies by which the carrier signal is generated. In one embodiment, the determination of whether a particular frequency has been used occurs by analyzing a checksum of the carrier signals transmitted from transmitting device 12 to receiving device 14. Ideally, the checksum of the carrier signal when transmitted by transmitting device 12 should be the same when received by the intended receiving device 14. If the checksum is not the same, this discrepancy is an indication that multiple carrier signals or other signals are being transmitted on a single power line.

In one embodiment, a controller is coupled to devices 12 or 14 for verifying the carrier signal checksum. In the event that the checksum is not verified (i.e., the checksum as transmitted by transmitting device 12 differs from the checksum as received by receiving device 14), the controller may generate a signal causing transmitting device 12 to transmit the carrier signal at an alternative frequency. As such, the controller would generate a signal for receiving device 14 causing it to tune to/receive signals having the alternative frequency while disregarding signals not having the alternative frequency. It is recognized that although the checksum may be used as described above, virtually any type of signal identifier may be used to meet specific design criteria. In some embodiments, filtering of signals and tuning to a desired frequency may occur through the use of a resistor and capacitor network and/or a phase-locked-loop (PLL) device.

Now, referring to FIG. 2, the PLC system is shown being utilized in the context of a keyless entry system. As shown, vehicle 10 includes a handle 18 having a keypad 18a. In this embodiment, handle 18 may include a PLC transceiver (i.e., device that combines the transmitting device and the receiving device), which communicates with a vehicle devices to enable locking and unlocking of the vehicle's doors. The embodiment shown in FIG. 2 illustrates the use of the PLC system with “concealed illumination” technology. In some aspects, concealed illumination includes overlaying or molding a semi-transparent material over areas that are configured to illuminate. As shown, the semi-transparent material overlays a plurality of buttons 20 that are configured to illuminate when energized. When a proper sequence of buttons 20 are selected (e.g., pressed) the door(s) of vehicle 10 may be locked or unlocked. As shown, the keypad 18a requires a minimal number of connector wires including a power line 22 over which the PLC sinusoidal signals may be transmitted. Keypad 18a also includes a ground wire 24 and optional passive entry differential antenna wires 26 and 28. Conventional keyless systems, however, typically use upwards of ten discrete wires to enable concealed illumination as shown in FIG. 2. Based on the described embodiments, the PLC system reduces the number of wires required for controlling electrical devices.

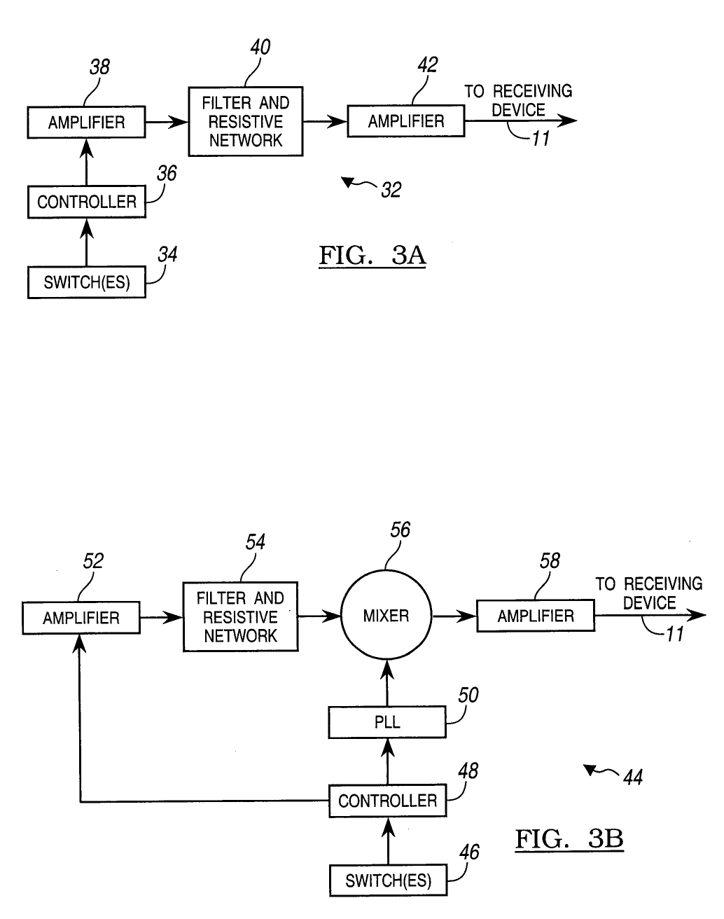

Now, referring to FIGS. 3A and 3B, alternative embodiments of a transmitting device are shown. Specifically, referring to FIG. 3A, transmitting device 32 includes a switch 34 that is coupled to a controller 36. Upon activation or placement of switch 34 in a predetermined position, controller 36 generates a control signal that enables the transmission of a sinusoidal carrier signal over a DC power line 11. Initially, an amplifier 38 receives the control signal from controller 36. In response, amplifier 38 generates a corresponding carrier signal for a filter and resistive network 40. Filter and resistive network 40 manipulates the signal to remove undesirable noise and to cause the signal to have a desired frequency. An amplifier 42 receives and amplifies the carrier signal from filter and resistive network 40 for transmission to a receiving device via power line 11.

Now, referring specifically to FIG. 3B, an alternative embodiment of a transmitting device (i.e., transmitting device 44) is shown that utilizes a PLL device 50. PLL 50 enables the selection of predetermined frequencies by which the carrier signal is transmitted over power line 11. Transmitting device 44 also includes a switch 46 that is coupled to a controller 48. In this embodiment, controller 48 is adapted to generate a control signal for PLL 50.

Controller 48 also generates a control signal for amplifier 52. As stated above, PLL 50 enables the selection of a predetermined frequency for the carrier signal that is generated by amplifier 52. In response to the control signal from controller 48, amplifier 52 generates the carrier signal as received by a filter and resistive network 54. A mixer 56 mixes signals from filter and resistive network 54 and PLL 50. Amplifier 58 then receives and amplifies the mixed signal from mixer 56. The carrier signal is then transmitted to a receiving device via power line 11.

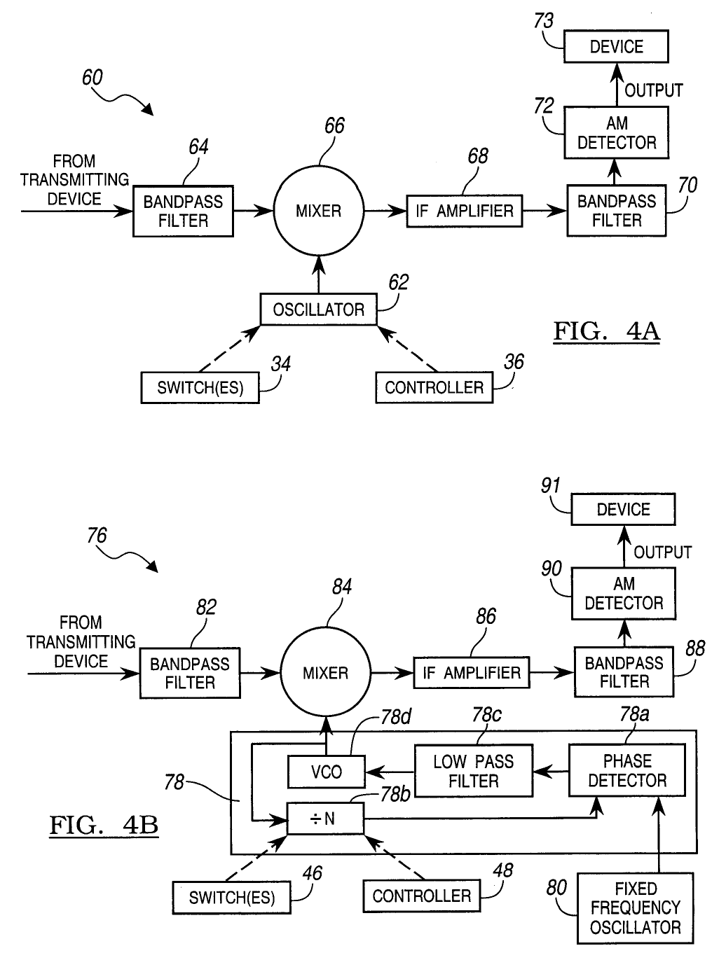

Referring to FIGS. 4A and 4B, alternative embodiments of receiving devices are illustrated. Specifically, as shown in FIG. 4A, controller 36 and switch 34 communicate with an oscillator 62. Oscillator 62 provides a reference signal that is mixed with signals from a band pass filter 64 through the use of a mixer 66. An amplifier 68, which may be an intermediate frequency (IF) amplifier, receives and amplifies the signal from mixer 66. Band pass filter 70 then filters the signal from amplifier 68 to adequately tune to the predetermined frequency. Additionally, an AM detector 72 modulates the filtered signal which is received by a device 73.

Referring to FIG. 4B, an alternative embodiment of a receiving device 76 that utilizes a PLL is illustrated. In this embodiment, controller 48 and switch 46 communicate with a PLL 78. A phase detector 78a receives a signal from a fixed frequency oscillator 80. Phase detector 78a also receives a signal from a frequency divider 78b. A low pass filter 78c also receives signals from phase detector 78a. A voltage controlled oscillator (VCO) 78d receives the filtered signal from 78c. VCO 78d then generates a signal for a mixer 84. The signal from VCO 78d is also fed back to frequency divider 78b.

A band pass filter 82 filters the signal received from a transmitting device. Mixer 84 mixes the signal filtered by filter 82 and the signal from VCO 78d. An amplifier 86, which may be an intermediate frequency (IF) amplifier, amplifies the signal from mixer 84. A band pass filter 88 then filters the amplified signal from amplifier 86. An AM detector 90 receives and modulates the filtered signal, which is then received at a device 91.

While the best mode for carrying out the invention has been described in detail, those familiar with the art to which this invention relates will recognize various alternative designs and embodiments for practicing the invention as defined by the following claims.

What is claimed:

1. A control system configured to communicate over a power line, the system comprising:
a transmitting device configured to generate a carrier signal having a predetermined frequency over the power line; and
a receiving device configured to filter signals not having the predetermined frequency and receive the carrier signal, the receiving device activating an electrical device in response to the carrier signal.

2. The system of claim 1, wherein the transmitting device is configured to determine whether to select a second predetermined frequency at which to transmit the carrier signal based upon verification of a checksum of the carrier signal, the transmitting device transmitting transmit the carrier signal having the second predetermined frequency when the checksum is not verified.

3. The system of claim 2, wherein the receiving device is configured to receive the carrier signal having the second predetermined frequency and filter signals not having the second predetermined frequency.

4. The system of claim 3, wherein the receiving device is configured to filter signals through the use of a phase locked loop (PLL) device.

5. The system of claim 1, wherein the electrical device includes a vehicle lamp.

6. The system of claim 1, wherein the electrical device includes a keypad handle.

7. The system of claim 1, wherein the carrier signal includes a sinusoidal signal.

8. The system of claim 1, wherein the power line includes a direct current power line.

9. A method of communicating over a power line, the method comprising:
transmitting a carrier signal having a predetermined frequency over the power line; and
filtering signals not having the predetermined frequency;
receiving the carrier signal via a receiving device; and
activating an electrical device in response to the carrier signal.

10. The system of claim 9, further comprising:
determining whether to select a second predetermined frequency at which to transmit the carrier signal; and
transmitting the carrier signal having the second predetermined frequency based on the determination of whether to select the second predetermined frequency.

11. The method of claim 10, further comprising:
receiving the carrier signal having the second predetermined frequency; and
filtering signals not having the second predetermined frequency.

12. The method of claim 11, wherein filtering signals occurs through the use of a phase locked loop (PLL) device.

13. The method of claim 9, wherein the electrical device includes a vehicle lamp.

14. The method of claim 9, wherein the electrical device includes a keypad handle.

15. The method of claim 9, wherein the carrier signal includes a sinusoidal signal.

16. A control system for a vehicle configured to communicate over a direct current power line that is routed though the vehicle, the system comprising:
a transmitting device mounted on the vehicle and being configured to transmit a first carrier signal having either a first predetermined frequency or a second predetermined frequency over the direct current power line, wherein the transmitting device determines whether to transmit the first carrier signal having the first predetermined frequency or second predetermined frequency based on whether a second carrier signal is being transmitted having either the first predetermined frequency or the second predetermined frequency; and
a receiving device mounted on the vehicle and being configured to automatically tune to the frequency of the first carrier signal, receive the first carrier signal and filter signals not having the transmitted frequency of the first carrier signal, the receiving device activating an electrical device in response to the first carrier signal.

17. The system of claim 16, wherein the receiving device is configured to filter signals through the use of a phase locked loop (PLL) device.

18. The system of claim 16, wherein the electrical device includes a vehicle lamp.

19. The system of claim 16, wherein the electrical device includes a keypad handle.

20. The system of claim 16, wherein the carrier signal includes a sinusoidal signal.
